(19) United States
(12) Patent Application Publication
(10) Pub. No.: US 2025/0242471 A1
(43) Pub. Date: Jul. 31, 2025

(54) Method For Pre-Profiling A Grinding Tool

(71) Applicant: Reishauer AG, Wallisellen (CH)

(72) Inventors: Marin Pavlovic, Brüttisellen (CH); Reto Weibel, Flawil (CH)

(73) Assignee: Reishauer AG, Wallisellen (CH)

(21) Appl. No.: 19/039,445

(22) Filed: Jan. 28, 2025

(30) Foreign Application Priority Data
Jan. 30, 2024 (CH) 000106/2024

(51) Int. Cl. B24B 53/075; B24B 53/06

(52) U.S. Cl. CPC B24B 53/075; B24B 53/062

(57) ABSTRACT

In a method for pre-profiling a grinding tool, a device, in particular a gear grinding machine, for hard fine machining of workpieces and for pre-profiling grinding tools is provided, which includes a workpiece spindle for rotating a workpiece, a grinding spindle, which is feedable at least along an X-grinding-spindle-infeed-axis, for rotating a grinding tool, in particular a grinding worm or a grinding wheel, and a profiling device with a fixed first profiling plate. A grinding tool blank, in particular a grinding worm blank, is provided on the grinding spindle of the device. The device is brought into a profiling configuration. The grinding spindle is fed until the grinding tool blank is operatively connected to the first profiling plate. Finally, the grinding tool blank is pre-profiled.

### CROSS-REFERENCE TO RELATE APPLICATIONS

This application claims the benefit of the filing date of Switzerland Application No. CH 000106/2024, filed Jan. 30, 2024, the disclosure of which are incorporated herein by reference in their entirety.

### FIELD OF THE INVENTION

The invention relates to a method for pre-profiling a grinding tool and a device for hard fine machining of workpieces and for profiling grinding tools.

### BACKGROUND OF THE INVENTION

In the case of the hard fine machining of workpieces, for example gear wheel blanks, these are machined with grinding tools such as grinding wheels or grinding worms. An advantageous method is generating grinding by means of gear grinding machines. It is important here that the grinding tools used have a profile, which fits exactly to the desired profile shape of the workpiece. This is achieved, inter alia, by the corresponding profiling of a tool blank. The profiling includes pre-profiling to obtain the required rough profile and dressing for fine profiling. The pre-profiling of grinding tool blanks usually takes place once on profiling machines designated for this purpose, such as, for example, circular grinding machines, while the dressing takes place on the gear grinding machine, for example a generating grinding machine, and is repeated periodically after a certain period of use. For the pre-profiling, for example, line dressing is carried out with radius profile rollers, which although offering a relatively high flexibility means a high expenditure of time. Particularly rotating dressing tools also have the disadvantage that, for example in the case of improper use, damage to the grinding tool blank easily occurs. The pre-profiling is therefore usually not carried out by the user of the grinding machines, in particular of the generating grinding machines, themselves, but by suppliers who have corresponding machines. The user acquires already pre-profiled grinding tools and stores them for future uses. This limits him in his flexibility and means a financial burden, since the customer has to pre-estimate his need for profiled grinding tools.

It is known from the prior art to use a so-called dressing master for the pre-profiling. This is in particular a diamond tool, which corresponds in its shape to the desired profile shape of the workpiece to be machined. Such a dressing master can then, for example, also be clamped in a grinding machine, in particular like a workpiece, and brought into operative connection with a grinding tool blank. As a result, a profile is introduced into the grinding tool blank, which corresponds to a negative of the profile of the dressing master.

However, this type of method in turn has the disadvantage that it is relatively inflexible. A corresponding dressing master is required for each workpiece shape. In addition, there are problems in the production of profiles which correspond to comparatively small workpieces, for example with a modulus of <1 mm.

### BRIEF SUMMARY OF THE INVENTION

The object of the invention is to provide a method which belongs to the technical field mentioned at the beginning and which permits flexible and demand-oriented pre-profiling of grinding tools with a device which is also suitable for hard fine machining of workpieces.

According to an aspect of the invention, a method for pre-profiling a grinding tool includes the steps of:
a) providing a device, in particular a gear grinding machine, for hard fine machining of workpieces and for pre-profiling grinding tools, including:
   a. a workpiece spindle for rotating a workpiece;
   b. a grinding spindle, which is feedable at least along an X-grinding-spindle-infeed-axis, for rotating a grinding tool, in particular a grinding worm or a grinding wheel, and
   c. a profiling device with a fixed first profiling plate.
b) providing a grinding tool blank, in particular a grinding worm blank, on the grinding spindle of the device.
c) bringing the device into a profiling configuration.
d) feeding the grinding spindle until the grinding tool blank is operatively connected to the first profiling plate.
e) pre-profiling the grinding tool blank.

A further aspect of the invention is a device, in particular a gear grinding machine, for hard fine machining of workpieces and for profiling grinding tools, in particular with a method according to the invention, including:
a) a workpiece spindle for rotating a workpiece;
b) a grinding spindle, which is feedable at least along an X-grinding-spindle-infeed-axis, for rotating a grinding tool, in particular a grinding worm or a grinding wheel, wherein the device has a workpiece-machining-configuration in which the grinding spindle can be fed to the workpiece spindle along the X-grinding-spindle-infeed-axis until a grinding tool located on the grinding spindle is operatively connected to a workpiece located on the workpiece spindle; and
c) a profiling device, including a fixed first profiling plate, wherein the device has a first profiling configuration in which the grinding spindle can be fed to the profiling device until the grinding tool located on the grinding spindle is operatively connected to the first profiling plate.

A workpiece here means in particular a gear wheel blank which still has to be machined by hard fine machining such as generating grinding in order to be usable as a gear wheel, for example in a gear mechanism. As a rule, such workpieces consist of metal, for example hardened steel.

In the context of the invention, a grinding tool, in particular a grinding worm or a grinding wheel, is a tool which is suitable for hard fine machining of workpieces. In particular, such grinding tools consist of a shaping and binding medium and of grains which are bound in the medium and which usually are harder than the material of the workpiece to be machined. The medium can be ceramic, while the grains consist, for example, of fused or sintered corundum.

For suitable hard fine machining of a workpiece, grinding tools have a profile, which corresponds to a negative of the desired profile shape of a workpiece. In the case of grinding worms, this profile winds spirally around the outer side of the grinding worm, so that the latter has a plurality of teeth, similar to a gear wheel, in cross section. In the case of a grinding wheel, in turn, the profile merely corresponds to the shape of a pitch profile of the finished gear wheel, that is to say a left tooth flank, a root region and a right tooth flank or a negative thereof.

A grinding tool blank is a blank of the grinding tool and becomes a suitable tool only by introducing a profile.

With the provision of a corresponding device, in particular a gear grinding machine, preferably a generating grinding machine, this device is made available for use for the remainder of the method. According to the invention, this is a device having the abovementioned features:

The workpiece spindle serves to rotate workpieces during hard fine machining. During generating grinding, this takes place continuously while the workpiece is operatively connected to a grinding worm, similar to a worm gear mechanism. If a grinding wheel is used, for example during pitch profile grinding, the workpiece is only rotated further as long as the grinding wheel and workpiece are not in engagement.

The grinding spindle holds and rotates a grinding tool. Usually, its grinding spindle rotation axis is inclined to the workpiece rotation axis of the workpiece spindle, in particular at an angle of 90°, but is tiltable in the process. The grinding spindle rotates the grinding tool at a rotation speed which is adapted to the respective grinding operation or profiling operation.

In the process, the grinding spindle is feedable at least along an X-grinding-spindle-infeed-axis. In other words, it is thus movable to a workpiece located on the workpiece spindle in order to bring a grinding tool into operative connection with the workpiece. For this purpose, the grinding spindle is arranged in particular on a movably mounted grinding slide.

The X-grinding-spindle-infeed-axis is in particular a movement axis which runs orthogonally to the rotation axis of the grinding spindle and also orthogonally to the rotation axis of the workpiece spindle. The X-grinding-spindle-infeed-axis preferably runs horizontally.

The profiling device according to the invention is suitable for preprofiling a grinding tool blank. For this purpose, it necessarily includes at least one fixed first profiling plate. The fact that the first profiling plate is fixed means that it is fixed in a non-rotating manner during a profiling operation and in the meantime cannot rotate about a rotation axis, in particular a rotation axis which runs parallel and/or orthogonally to the grinding-spindle rotation axis. In this case, the first profiling plate is plate-shaped. In the direction, which runs parallel to the grinding spindle rotation axis, the first profiling plate, in an engagement region, is in particular less wide than the tooth thickness of the gearwheels for which the grinding tool blank is provided. In particular, the profiling plate has a maximum length, which is less than, for example, the smallest diameter of the workpiece spindle.

The first profiling plate—in contrast to, for example, grinding wheels—is in particular also not rotationally symmetrical during rotations about axes which lie orthogonally to one of its main surfaces and pass through the first profiling plate. In particular, the first profiling plate, in a distal region, which points towards the grinding spindle during the pre-profiling (see below), is arrow-shaped or triangular, with a tip, which points towards the grinding spindle. The first profiling plate, at least in the profiling configuration of the device, is preferably oriented such that its main surfaces lie horizontally.

The first profiling plate consists in particular of a material or includes a material, which is harder than hardened steel, for example diamond (see below).

When providing a grinding tool blank on the grinding spindle, the grinding tool blank is arranged on the grinding spindle such that the grinding spindle can rotate it. In particular, the grinding tool blank is therefore attached in the same way as an already finished profiled grinding tool would also be attached to the device in order to machine a workpiece.

Bringing the device into a profiling configuration includes all steps which bring the device into a configuration (the first profiling configuration) in which the grinding spindle can be fed to the profiling device until the grinding tool blank is operatively connected to the first profiling plate. This means in particular that the first profiling plate is aligned with respect to the grinding spindle. Alternatively or additionally, depending on the specific device, it can also mean that the grinding spindle is moved, for example, along a Z-grinding-spindle-axis to a suitable vertical height, in particular the vertical height of the profiling device. It can also include removing a protection from the profiling device, for example, opening a protective hood, or folding out the profiling device. Likewise, assuming the profiling configuration means that the first profiling plate is fixed (if this was not the case beforehand) in such a way that it is not freely movable and/or rotatable. Specifically, for example, in devices in which the workpiece spindle is arranged, in particular next to a carrier tower, on a movable base, bringing the device into the profiling configuration also includes a suitable rotation or alignment of this base (see below).

In the process, the feeding can take place along the X-grinding-spindle-infeed-axis. It is also possible that an infeed-axis to the profiling device deviates from the X-grinding-spindle-infeed-axis and is, for example, orthogonal thereto and the feeding takes place, for example, vertically upward. In particular, the feeding can also take place along a Y-grinding-spindle-axis parallel to the grinding spindle axis. In this case, the grinding-tool blank is initially positioned relative to the first profiling plate, for example by moving along the X-grinding-spindle-infeed-axis, in such a way that a straight line parallel to the grinding spindle axis exists, which runs both through the tip of the first profiling plate and through an outer region of the grinding-tool blank.

Pre-profiling the grinding-tool blank includes feeding the grinding spindle with the grinding-tool blank to the profiling device until the grinding-tool blank is operatively connected to the first profiling plate. In addition, it includes the grinding spindle setting the grinding-tool blank in rotation. During the rotation of the grinding-tool blank, material removal occurs as a result of its interaction with the first profiling plate. This leads to the profiling, in particular the pre-profiling, of the grinding tool blank. Preferably, the pre-profiling includes still further movements of the grinding spindle, for example, movements in the Y-grinding-spindle-axis parallel to the grinding spindle rotation axis. In the case of a grinding worm blank, for example, the grinding spindle is also moved, suitably to the rotation speed, in particular along the Y-grinding-spindle-axis, along the profiling device in such a way that the removal winds spirally around the grinding-tool blank in the desired manner. Further details of this variant are described further below in the text.

In the case of a grinding-wheel blank, in turn, the grinding spindle is moved, if at all, only in such a way that the removal produces a desired profile shape.

The advantage of the method according to the invention and of the device according to the invention is that a grinding tool blank can be pre-profiled with the same device, with which a hard fine machining of a workpiece can then also be carried out. It is thus possible for a user of this device, for example, to provide grinding tool blanks and to pre-profile them as required, in order to use them as grinding tools in subsequent hard fine machinings. Also, no dressing masters specific to each gear-wheel shape are required. This permits a particularly flexible and demand-oriented pre-profiling.

In addition, by using the first profiling plate, profiling can be carried out more rapidly, since this produces a high level of abrasion. The profiling can also be carried out dry, that is to say in particular without the addition of cooling oil. The method thus becomes particularly simple.

A further advantage is the possibility, with the method and/or the device, of producing profiles which are capable of grinding relatively fine toothings. In particular, grinding tools which are suitable for grinding gearwheels with a modulus of <1, in particular up to a modulus of 0.5, can thus be pre-profiled in a simple, flexible and demand-oriented manner. This leads to a particularly flexible and universal method and a likewise particularly flexible and universal device.

Bringing the device into the profiling configuration preferably includes moving the first profiling plate, in particular pivoting the first profiling plate, along a circular path into a grinding tool machining position. The grinding tool machining position is in this case a position, which the first profiling plate has in the profiling configuration and maintains in particular during a complete profiling operation. In this case, the movement can take place, for example, rectilinearly horizontally or else, e.g. rectilinearly vertically. It preferably takes place horizontally along a circular path. In this case, the first profiling plate can be pivoted, for example, along a vertical pivot axis, which lies outside the first profiling plate, particularly preferably also outside the profiling device. However, the profiling plate can also be pivoted along a horizontally running pivot axis into the grinding tool machining position. Moving the first profiling plate into the grinding tool machining position permits bringing the device into a profiling configuration in a simple and very rapid manner. The profiling device and the first profiling plate can be of comparatively compact design in relation to other components of the device, and movement of the first profiling plate can therefore be implemented easily and can take place in particular rapidly.

Alternatively, bringing the device into the profiling configuration can also take place without movement of the first profiling plate, for example via movement of the grinding spindle, or in that, for example, feeding to the profiling device takes place in an infeed axis other than the X-grinding-spindle-infeed-axis.

In a preferred variant of the abovementioned variants of the invention, bringing the device into the profiling configuration includes moving the grinding spindle along a Z-grinding-spindle-axis, which runs parallel to a workpiece rotation axis, into a grinding spindle profiling height. This means moving the grinding spindle before feeding to the profiling device. This provides a method, which can also be used in profiling devices which are arranged, for example, at a different height on the device than a workpiece located on the workpiece spindle. In particular, a device can thus be used in which the profiling device is located above the clamping region of the workpiece spindle or below the clamping region of the workpiece spindle. Such a method also permits a profiling device which is arranged fixedly, that is to say immovably, and which is spaced apart from the workpiece spindle only in the vertical height. The method thus becomes particularly flexible.

Alternatively, the method can also be carried out without movement along the Z-grinding-spindle-axis, for example if the profiling device in the profiling configuration lies at the same height as a workpiece located on the workpiece spindle, or if the infeed axis to the profiling device is a different axis than the X-grinding-spindle-infeed-axis.

In a preferred embodiment of all abovementioned variants of the invention, the first profiling plate, after completion of the pre-profiling, is moved into a waiting position, in which the first profiling plate is located outside a feeding region between the grinding spindle and the workpiece spindle.

The waiting position is in particular a position in which the first profiling plate does not hinder a feeding of the grinding spindle to the workpiece spindle and in which it can also remain during a grinding operation. The feeding region includes, for example, the, in particular smallest, spatial region, which includes all positions of a grinding tool during feeding to the workpiece spindle, and in particular also during a grinding operation of a workpiece. By moving the profiling plate into the waiting position, the device for concluding the method according to the invention can be made available particularly rapidly for hard-precision machining of a workpiece. Thus, the method becomes particularly easy to integrate into sequences, which provide both a pre-profiling of a grinding tool and a hard fine machining of a workpiece.

Alternatively, the first profiling plate can also remain unmoved after completion of the pre-profiling. This can be used, for example, in methods in which the heights of the profiling device and of a workpiece located on the workpiece spindle differ along the Z-grinding-spindle-axis.

In a preferred embodiment of the invention, during the pre-profiling, the grinding spindle, in a Y-operative-connection-movement-region, within which the grinding tool blank located on the grinding spindle remains operatively connected to the first profiling plate, is moved along a Y-grinding-spindle-axis, which Y-grinding-spindle-axis runs parallel to a grinding spindle rotation axis of the grinding spindle.

In other words, the Y-operative-connection-movement-region denotes a movement region in which, after feeding, the grinding spindle can move along the Y-grinding-spindle-axis to the profiling device without the grinding tool and the first profiling plate coming out of operative connection. This can be a region which is wider along the Y-grinding-spindle-axis than the width of the desired profile, or the width of which corresponds to the width of the desired profile. As a result of a movement of the grinding spindle with the grinding-tool blank, a spiral profile can thus be produced, in particular on grinding worm blanks. This movement is also referred to as shifting. In particular, in this case, the width of the desired profile is passed through completely once from one side to the other side, and the grinding spindle is then returned and moved again, along the Y-grinding-spindle-axis and in particular also along the X-grinding-spindle-axis, into the starting position. This can be repeated several times. In particular, after the return, a position, which deviates from the starting position can also be assumed in order, for example, in the new pass, to profile a second flank which lies opposite a first flank of a profile. The speed of the movement along the Y-grinding-spindle-axis is in this case coordinated in particular with the rotation speed of the grinding spindle in order to obtain the desired profile.

This permits flexible pre-profiling in particular of grinding worms, wherein customary movement possibilities of gear grinding machines, in particular generating grinding machines, and typical grinding and shifting carriages are utilized. Even in the case of the pre-profiling of grinding wheels, a movement can take place along the Y-grinding-spindle-axis in order to obtain the desired profile.

The method thus becomes particularly simple and universally usable and also particularly flexible and demand-oriented.

Alternatively, the grinding spindle can remain unmoved and, for example, the profiling device or the first profiling plate can be moved, for example, parallel to the grinding spindle rotation axis. This is in particular a variant for gear grinding machines, which do not permit any movements of the grinding spindle along the Y-grinding-spindle-axis.

In a preferred embodiment of the invention, during the pre-profiling, a clamping foot of a profiling plate holder contacts and supports one side of the first profiling plate, which side substantially has a surface normal, which points in the same direction as the rotation direction of the grinding tool blank in a local operative-connection-region of the grinding tool blank and the profiling plate.

The clamping foot of the profiling plate holder serves as a support of the profiling plate, which in particular prevents the profiling plate from breaking by forces during the profiling (see below). The local operative-connection-region is in particular the region of the grinding tool blank, which is operatively connected to the first profiling plate. The corresponding rotation direction is thus in particular the direction of the force, which the grinding tool blank exerts on the profiling plate. In particular, the supported side is a main surface of the first profiling plate. A support of the side, the surface normal of which points in the same direction, thus counteracts this force effect and prevents in particular a bending or a breaking of the first profiling plate during the profiling operation.

The method thus becomes particularly reliable and also sustainable.

Alternatively, the method can also be carried out without a clamping foot, or the clamping foot can be oriented differently. It is necessary here to use a first profiling plate, which has the necessary stability even without support.

In a preferred embodiment of the invention, before bringing the device into the profiling configuration, a measurement of the first profiling plate is carried out, wherein, for the measurement, the first profiling plate is brought into contact with a probe, in particular successively at least two contact points of the profiling plate. An essential factor which influences the quality of the result and thus of the method is the precise knowledge of the profiling plate geometry. This knowledge is required in particular so that the movements involved, such as the advancing and, for example, the shifting, can be planned correctly. However, the profiling plate geometry changes from the initial geometry during each profiling operation as a result of wear.

A measurement here is in particular a method in which knowledge about the geometry of the first profiling plate is collected, in particular about the geometry of the parts of the profiling plate which come into operative connection with the grinding tool blank. The probe, in particular a measuring cube, with its in particular well-known geometry and alignment in the device is brought into contact with the first profiling plate, for example via movements which are also recorded. For example, the geometry of the first profiling plate can then be scanned by knowledge of the exact position of the probe during the contact. In particular, in this case the probe is moved while the first profiling plate remains unmoved. The probe can include, for example, a contact sensor, such as, for example, a capacitive sensor, or a laser measuring system, with which a contact is registered. The contact can also be established via observation by an operator, for example by means of a camera. The probe is preferably brought into contact with the first profiling plate successively in a plurality of positions. In particular, the probe is brought into contact with the outermost tip of the first profiling plate, in particular pointing towards the grinding spindle in the profiling configuration, and, for example, with two opposite points on the sides of the first profiling plate. Of course, the probe can be brought into contact with even more locations on the first profiling plate in order to improve the resolution. However, it has been shown in tests that, in particular with three contacts, in this case preferably a contact on the outermost tip of the first profiling plate and in each case one on opposite flanks of the first profiling plate, a particularly efficient and nevertheless precise method is achieved.

The geometry of the first profiling plate can then be reconstructed from the various contact locations or positions of the probe. The result of the measurement is preferably used as an input in the planning of the pre-profiling, in particular for planning the movements of the grinding spindle, for example by a grinding slide and/or a shift slide. The result can also be used to decide whether the first profiling plate should be replaced.

An efficient and nevertheless particularly reliable and high-quality method is provided by this additional step.

In a particularly preferred variant of the method described above, before the measurement of the first profiling plate, the probe is fed to the profiling device until the probe and the first profiling plate contact each other. In particular, in this case the probe is fed along the X-grinding-spindle-infeed-axis.

This has the advantage that already existing moving components present in a gear grinding machine, such as a grinding slide, are also used for moving the probe. In particular, for this purpose the probe is brought into a measuring configuration before feeding, in which it lies, for example, in front of the grinding spindle and the grinding tool blank. It can then be fed in the same way as the grinding spindle in the profiling configuration.

A particularly simple and efficient method is thus provided. Alternatively, the probe can also be brought into contact with the first profiling plate in a different way, for example by moving the profiling device or pivoting the probe onto the profiling device.

Alternatively, the measurement can also be dispensed with. A possible alternative method is explained further below in the text. If there is sufficient experience with wear, it can also be provided, for example, to replace the first profiling plate after a predefined number of profiling operations and then to start with a new well-known geometry.

In a preferred embodiment of the invention, before bringing the device into a profiling configuration or before the pre-profiling, for the purpose of planning the pre-profiling, a digital twin of the first profiling plate is called up, which digital twin represents a previous state of wear of the first profiling plate, wherein, during the pre-profiling or after the pre-profiling, the digital twin is updated, in particular by a simulation, such that it represents an updated state of wear of the first profiling plate. In particular, the digital twin can serve as an alternative to the measurement with a probe, but also, for example, as a supplement. The planning of the pre-profiling therefore includes, in particular, the determination of the necessary movements, which are carried out before and during the profiling, in particular a feed distance, but also, for example, a shift distance.

The digital twin is a digital representation of the first profiling plate, which digital representation is stored, for example, on a hard disk of a PC or a control unit. In particular, it represents the geometry of the profiling plate and/or its state of wear. However, it can represent additional factors, for example its age and its composition, for example a material from which the first profiling plate, in particular a cutting element of the first profiling plate, consists. By calling up the digital twin, it is possible, in particular, to read out a geometry which corresponds to the geometry of the first profiling plate. This can be used to plan the pre-profiling.

In this case, the updating of the digital twin includes, in particular, a simulation, for example, a simulation with a finite element method (FEM). In this case, for example, movement data of the pre-profiling from the planning, or recorded values, are used as an input for the simulation. The updated digital twin thus represents the changed geometry of the first profiling plate after the profiling operation and is available for further profiling operations.

A particularly efficient and precise method is thus provided which also considers the wear of profiling plates independently of measured values. Alternatively, a digital twin can also be dispensed with, for example, in the case of the measurement described above.

In a variant of the device according to the invention, the grinding spindle in the first profiling configuration can be fed to the profiling device along the X-grinding-spindle-infeed-axis. This simplifies the construction of the device, since the same infeed axis serves both for feeding the finished profiled grinding tool to workpieces and for feeding the grinding tool blank to the profiling device.

Alternatively, the feeding can also take place along, for example, the vertical Z-grinding-spindle-axis, if, for example, the profiling device is arranged above the grinding spindle.

In particular for pre-profiling grinding worms, the grinding spindle in a grinding worm profiling configuration can be fed to the profiling device along the Y-grinding-spindle-infeed-axis. For this purpose, the grinding tool blank can be positioned relative to the first profiling plate, for example by moving along the X-grinding-spindle-infeed-axis, in such a way that a straight line parallel to the grinding spindle axis exists, which runs both through the tip of the first profiling plate and through an outer region of the grinding-tool blank.

In a preferred variant of the device, the first profiling plate is movable, in particular pivotable, into a waiting position, in which the first profiling plate is located outside a feeding region along the X-grinding-spindle-infeed-axis between the grinding spindle and the workpiece spindle. The waiting position can be located, for example, in relation to the workpiece spindle in a spatial region lying opposite the grinding spindle. If the device includes a carrier tower (see below), the waiting position can be located, in particular, on a side of the carrier tower lying opposite the workpiece spindle.

By moving into the waiting position, the device for concluding the method according to the invention can be made available particularly rapidly for hard precision machining of a workpiece. The device is thus particularly flexible and permits a simple, reliable and rapid transition from the first profiling configuration into a workpiece machining configuration.

Alternatively, the first profiling plate can also be fixed immovably, for example. This can be used, in particular, in solutions in which the height of the profiling device, on the one hand, and of a workpiece located on the workpiece spindle, on the other hand differs along the Z-grinding-spindle-axis.

In a preferred embodiment of the device according to the invention, the profiling device includes a pivotably mounted pivot arm, wherein the first profiling plate is arranged at a distal end of the pivot arm.

In this case, the pivot arm is pivotable, in particular, about an axis, which runs parallel to the rotation axis of the workpiece spindle, in particular vertically. In particular, the pivot arm is substantially cuboidal, with a vertical height, which corresponds to more than 50% of the horizontal length of the pivot arm and a width, which corresponds to more than 40% of its length. This ensures sufficient stability of the pivot arm, even during the force-intensive profiling operations. The length of the pivot arm, measured, for example, from the free end to its pivotable mounting, is, in particular, less than 20 times a maximum length of the first profiling plate.

For the mounting of the pivot arm, the profiling device can also include, in particular, a pivot arm base, on which pivot arm base the pivot arm is pivotably mounted.

A profiling device with a pivot arm has the advantage that the first profiling plate can be arranged on the device such that it can be easily folded out and folded in, with which the profiling device can be arranged in a less exposed position in the device. This prevents damage to the first profiling plate, for example, during secondary machining or during the pivoting of the entire profiling device. This makes it possible to construct an overall more compact device. In addition, by pivoting the pivot arm, the first profiling plate can be flexibly aligned with respect to the grinding worm or the alignment can be adapted, such that different profile flank geometries can be produced in a simple manner.

Alternatively, the profiling device can also be designed without a pivot arm if, for example, sufficient space is available.

In a preferred embodiment of the device according to the invention, the grinding spindle is movable along a Y-grinding-spindle-axis, which Y-grinding-spindle-axis runs parallel to a grinding spindle rotation axis of the grinding spindle, and in particular orthogonally to the X-grinding-spindle-infeed-axis. In this case, in the first profiling configuration, a Y-operative-connection-movement-region exists, within which a grinding tool located on the grinding spindle is operatively connected to the first profiling plate. In particular, the Y-grinding-spindle-axis runs horizontally. The grinding spindle can preferably be arranged, for example, on a shift slide which is movably mounted along the Y-grinding-spindle-axis. The advantages of the Y-operative-connection-movement-region have already been discussed further above in the text with reference to the corresponding method. A particularly simple device is thus provided which is simultaneously suitable for hard fine machining of workpieces and for pre-profiling grinding worm blanks. Alternatively, the profiling device can be designed to be shiftable, that is to say movable parallel to the grinding spindle rotation axis.

The grinding spindle is preferably movable along a Z-grinding-spindle-axis, which Z-grinding-spindle-axis runs parallel to a workpiece rotation axis of the workpiece spindle, and in particular orthogonally to the X-grinding-spindle-infeed-axis, wherein the grinding spindle assumes a grinding spindle profiling height along the Z-grinding-spindle-axis in the workpiece-machining-configuration.

In particular, for this purpose, a shift slide, on which the grinding spindle is arranged, is movably mounted along the Z-grinding-spindle-axis. In this case, the Z-grinding-spindle-axis runs, in particular, vertically.

The movability along the Z-grinding-spindle-axis permits the profiling device to be attached at a height which deviates from the height of a workpiece located on the workpiece spindle. The device can thus be constructed compactly and flexibly.

In a preferred variant of the invention, the device includes a, in particular rotatably mounted, carrier tower, wherein the carrier tower has in particular a workpiece carrier for transporting a workpiece to the workpiece spindle.

Carrier towers for gear grinding machines are known per se. A carrier tower is in particular a, for example substantially cylindrical, component which carries various functional elements of a gear grinding machine. In this case, the carrier tower is located, in particular, opposite or in front of the grinding spindle. In particular, by means of a rotatable carrier tower, various functional elements can be brought selectively into an interaction position with the grinding spindle, such as, for example, a dressing device. The carrier tower includes in particular a workpiece carrier, which can fix workpieces in such a way that they can be transported. The workpiece carrier can also be designed to transport, for example, grinding tool blanks to the grinding spindle.

Owing to the presence of a carrier tower, the device can be used in a particularly versatile manner and is compact in this case. Alternatively, it can also be designed without a carrier tower.

In a preferred alternative of the above variant of the invention, the carrier tower is rotatable or pivotable into a carrier-tower-profiling position.

The advantage of a rotatable or pivotable carrier tower is the possibility of arranging functional components fixedly on the carrier tower. Since most functional components, such as dressing devices or also the profiling device, are usually smaller than the carrier tower, a very stable and nevertheless flexible device can thus be achieved. Alternatively, the carrier tower can also be arranged in a rotationally fixed manner. In this case, the functional components can be arranged, for example, rotatably on the carrier tower, or possibly also the grinding spindle can be rotatably mounted around the carrier tower.

The profiling device is preferably arranged on the carrier tower. For this purpose, the profiling device can be arranged in particular on one of the side walls of the carrier tower.

This constitutes a particularly robust and also simple possibility of positioning the first profiling plate in the device. In this case, it can be arranged in particular on a side of the carrier tower facing away from the workpiece spindle or, for example, also at a different height than a workpiece located on the workpiece spindle.

In a preferred variant of the above embodiment, the carrier tower and the workpiece spindle are arranged on a rotatable base, wherein the profiling device, with respect to a base rotation axis, is arranged in an angular region outside a workpiece-spindle-angular-region on the carrier tower.

The rotatable base is known per se. In this case, such a base has in particular a round shape with respect to a horizontal plane. The base rotation axis runs, for example, centrally and vertically through the base. The workpiece-spindle-angular-region is in particular the angular region which the workpiece spindle assumes, with respect to the base rotation axis. In other words, this is the region within which straight connecting lines, starting from the base rotation axis and orthogonal to the base rotation axis, to a point on the workpiece spindle and in particular also to points on a workpiece attached to the workpiece spindle can be constructed. Outside means in particular that no point of the profiling device is located within the angular region of the workpiece spindle.

This arrangement has the advantage that the device can be brought into the profiling configuration in a very efficient and rapid manner. For this purpose, in particular only the base has to be rotated in such a way that the profiling device points towards the grinding spindle. In this case, the workpiece spindle and also, for example, a workpiece located on it, is simultaneously rotated away from the grinding spindle. Likewise, the profiling device is automatically in a waiting position as soon as the workpiece spindle faces the grinding spindle.

Alternatively, the profiling device can also be arranged, for example, above or below the workpiece spindle in the same angular region. The device can also be designed without a rotatable base.

In a preferred alternative of the above embodiment, the device includes a dressing device arranged on the carrier tower, wherein the profiling device is arranged on the dressing device.

The device according to the invention thus permits an additional dressing of a grinding tool, in particular after the pre-profiling. In particular, in this variant, the profiling configuration is identical or almost identical to a dressing configuration of the device, with which a pre-profiling with a subsequent dressing can be carried out particularly rapidly and efficiently. Alternatively, the profiling device can also be arranged separately from the dressing device, or the device can be designed without a dressing device.

In a further alternative of the invention, the device includes a workpiece tailstock arranged on the carrier tower with a tailstock base, wherein the profiling device is arranged on the tailstock base. It is known to arrange a tailstock by means of a tailstock base for holding the workpieces on the carrier tower. In this case, the tailstock can be movably mounted, in particular, vertically along the carrier tower. At least in the workpiece-machining-configuration of the device, the tailstock is located above the workpiece spindle and has the same rotation axis.

Arranging the profiling device on the tailstock base in this case makes it possible to change into the profiling configuration even in the case of no or only a slight rotation of the carrier tower, for example by a movement of the grinding spindle along the Z-grinding-spindle-axis. The device is thus constructed particularly efficiently and simply. In addition, the arrangement does not block any unused space on the carrier tower, as a result of which, for example, a particularly large number of further functional components can be arranged on the carrier tower.

In a preferred embodiment of the invention, the first profiling plate includes a cutting element with polycrystalline diamond (PCD). In particular, the first profiling plate consists of polycrystalline diamond (PCD), that is to say diamond particles which are surrounded by a metallic matrix. Alternatively, a cutting element can also be sintered onto a main body, for example a hard-metal main body.

Tests have shown that a first profiling plate with a cutting element made of polycrystalline diamond is particularly well suited for pre-profiling grinding tools. Alternatively, the first profiling plate can also comprise a cutting element made of another hard cutting material.

In a particularly preferred embodiment of all the above variants of the device, the first profiling plate has a first distal profiling-plate-tip-angle of 1° to 50°, in particular of 5° to 45°, particularly preferably of 10° to 30°.

The profiling-plate-tip-angle means in particular the inner angle of an outermost tip of the profiling plate. In this case, a narrow angle ensures that the first profiling plate is also particularly well suited for producing narrow profiles on a grinding tool blank.

In a preferred variant of the invention, the profiling device has a first profiling plate holder, which holds the first profiling plate, including
a) a first clamping foot, wherein the first clamping foot has a first receiving surface, which first receiving surface is in contact with the first profiling plate; and
b) a first clamping element, which presses the first profiling plate onto the first receiving surface.

The first profiling plate holder is in particular the connecting element, with which the first profiling plate is connected to the remainder of the device, for example a carrier tower wall. The first clamping foot is in particular the support of the first profiling plate, which receives the first profiling plate and supports it against displacements and breaking.

The first clamping element is located, in particular, on the first clamping foot. It is in particular smaller than the first clamping foot and presses the first profiling plate merely against the receiving surface. The clamping element can be fastened to the first clamping foot, in particular, with a screw or a bolt. In particular, both the clamping foot and the clamping element consist of steel or aluminum.

The first clamping element is, in particular, rotatably mounted, so that it can be rotated away from the receiving surface, for example, horizontally. Alternatively, it can be removed completely or partially from the first clamping foot, for example, by loosening a screw connection. This permits a simple removal and replacement of the first profiling plate, if it has become unusable, for example, as a result of wear.

In a preferred embodiment of the invention, a first receiving-surface-dimension of the first receiving surface is between 50% and 95% of a first profiling-plate-main-surface-dimension of the first profiling plate, in particular 80% or more.

The receiving-surface-dimension is in this case the surface of the receiving surface of the first clamping foot, it can be, for example, 200 mm². The profiling-plate-main-surface-dimension is in turn the surface of a main surface of the first profiling plate, in particular the surface of the side of the profiling plate which is in contact with the receiving surface. It can be, for example, 250 mm².

The first profiling plate is subjected to comparatively strong forces during a profiling operation. There is therefore the risk of the first profiling plate breaking, for example, during a profiling operation. The corresponding risk can be reduced with the large-surface support. Furthermore, the large-surface contacting also permits improved heat transport from the first profiling plate, which is likewise advantageous since the latter can heat up strongly in the event of friction.

However, a further requirement on the profiling device is that in particular only the first profiling plate comes into contact and operative connection with a grinding-tool blank. It is therefore advantageous to support the profiling plate on a clamping foot, the receiving area of which is smaller than the area of the first profiling plate, in particular in a distal region of the profiling device. Tests have shown that, with a receiving-surface-dimension of the first receiving surface between 50% and 95% of a first profiling-plate-main-surface-dimension, particularly good support of the first profiling plate takes place without the first clamping foot influencing a profiling operation. In particular, the receiving surface, in a distal region of the first clamping foot, is narrower than the first profiling plate. In this case, it is, in particular, arrow-shaped. In particular, the first clamping foot, measured behind or under the receiving surface parallel to the receiving surface, is not wider than the receiving surface. In other words, a projection of the first clamping foot onto a plane which runs parallel to the receiving surface produces, in a distal region, a profile which corresponds to the receiving surface.

Alternatively, the first clamping foot can have, for example, a smaller receiving surface.

In a preferred embodiment of the invention, the first clamping foot has a thickness perpendicular to the first receiving surface, which corresponds to at least 70%, in particular at least 100%, of a maximum length of the receiving surface. In order to support the first profiling plate, a sufficient volume of the first clamping foot is necessary.

Alternatively, the clamping foot can also be thinner. However, this necessitates, in particular, a careful selection of material.

The thickness is in this case in particular the average thickness of the first clamping foot at all locations of the first receiving surface.

In a preferred embodiment of the invention, the clamping foot has, adjacent to the first receiving surface, in particular perpendicular to the first receiving surface, at least one first stabilizing surface, which supports the first profiling plate against slipping within the first profiling plate holder, in particular at least in one direction parallel to the stabilizing surface. The stabilizing surface has in this case in particular a shape, which corresponds to the shape of the side of the first profiling plate, which is in contact with the stabilizing surface. The stabilizing surface is oriented, for example, orthogonally to the receiving surface. In particular, it can also be oriented at an angle to the receiving surface, wherein an inner angle is less than 90°. In particular, the first profiling plate is then designed such that it also has an oblique side, which is then also supported by the stabilizing surface against movements away from the receiving surface.

The stabilizing surface leads in a simple manner to a very stable mounting of the first profiling plate. The device thus becomes particularly reliable and robust.

A, in particular cylindrical, stabilizing pin which engages in a recess of the first profiling plate is preferably located on the receiving surface. Said stabilizing pin supports a correct positioning of the first profiling plate on the receiving surface and also absorbs forces which act on the first profiling plate parallel to the receiving surface.

In a variant of the invention, the first clamping foot in the first profiling configuration of the device is located above the first clamping element. This has the advantage that, during a profiling operation, a grinding tool blank can be rotated such that its force acting on the first profiling plate points upward. This has the consequence that resulting chips can fall freely downward and do not accumulate on the first profiling plate.

Alternatively, it is readily possible to position the clamping foot below the first profiling plate.

In a preferred variant of all the above embodiments of the invention, the profiling device includes a second profiling plate, in particular also a third profiling plate, preferably also a fourth profiling plate.

In particular, the device has corresponding further profiling configurations in which the grinding spindle can be fed to the respective profiling plate.

Thus, for example, various profiling plate shapes can be used in the same device, with which the device becomes even more flexible. Additionally or alternatively, a quickly usable reserve can thus also be present. In particular, a profiling operation can thus also be continued or a further profiling operation can take place in the case of a breakage, for example, of the first profiling plate by a change of the profiling configuration and thus of the profiling plate. In addition, various profiling plates, for example, the first profiling plate and the second profiling plate, can be designed as a roughing or finishing plate. Thus, roughing and finishing can be carried out with different designated profiling plates. Thus, for example, a profiling plate, in particular the third profiling plate, can also be designed as a contour plate, which is provided for contour sections.

The device thus becomes particularly reliable and flexible. Alternatively, the device can also comprise merely one, that is to say the first, profiling plate.

The profiling plates of the profiling device preferably have a first profiling-plate-tip-angle of the first profiling plate and a second profiling-plate-tip-angle of the second profiling plate, in particular also a third profiling-plate-tip-angle of the third profiling plate, particularly preferably also a fourth profiling-plate-tip-angle of the fourth profiling plate, wherein the profiling-plate-tip-angles in each case have a difference from one another of at least 2°, in particular at least 3°.

The deviations of the profiling-plate-tip-angles of the profiling plates ensure that a profiling plate fitting thereto can be selected depending on the desired profile. The device thus becomes particularly flexible and universally usable. Alternatively, the profiling-plate-tip-angles can also be identical overall or partially. The profiling plates can then serve as a replacement for one another.

A first distal profiling-plate tip of the first profiling plate and a second distal profiling-plate tip of the second profiling plate, in particular also a third distal profiling-plate tip of the third profiling plate, preferably also a fourth distal profiling-plate tip of the fourth profiling plate, are preferably arranged on a circular circumference with respect to an arrangement plane. In this case, the profiling device is pivotably or rotatably mounted about a transposition axis running orthogonally to the arrangement plane and centrally through the circular circumference, so that each profiling-plate-tip can be aligned with the grinding spindle, wherein the arrangement plane runs either parallel, in particular as a round table arrangement, or at an angle, in particular as a revolver arrangement, to a main surface of the first profiling plate.

In this case, the arrangement with respect to the arrangement plane is to be understood in particular such that the positions of the profiling-plate-tips are projected orthogonally to the arrangement plane onto the arrangement plane. Thus, in the case of an arrangement plane, which runs parallel to the first receiving surface, a difference in height of the profiling plates vertically with respect to the arrangement plane can still be meant. A round table arrangement means that the profiling-plate-tips are uniformly distributed along the circular circumference.

A revolver arrangement means that the arrangement plane runs such that the transposition axis, projected onto a horizontal plane, runs orthogonally to the grinding spindle rotation axis. A change of the profiling plate thus takes place by a revolver-like transposition or rotation.

These arrangements have the advantage that the profiling device can be of particularly compact design with more than one profiling plate and the device can change into a different profiling configuration particularly rapidly and efficiently.

In an alternative of the above embodiment of the invention, the profiling device is a stack-profiling-device, wherein a first distal profiling-plate-tip of the first profiling plate and a second distal profiling-plate-tip of the second profiling plate, in particular also a third distal profiling-plate-tip of the third profiling plate, preferably also a fourth distal profiling-plate-tip of the fourth profiling plate, are spaced apart from one another along a stacking axis, which runs orthogonally to a main surface of the first profiling plate, and are aligned identically with respect to a plane, which runs parallel to the main surface of the first profiling plate.

This has the advantage that the profiling device can be designed in particular without moving parts. It thus becomes particularly robust. The stack-profiling-device can also be mounted movably about the stacking axis, so that each profiling-plate-tip can be brought to a grinding-tool-machining-height. This in turn produces a profiling device, which assumes a particularly small angular region, for example on the carrier tower, and at the same time manages in particular without movements of the grinding spindle along the Z-grinding-spindle-axis.

The device preferably includes a probe, wherein the device has a first profiling-plate-measurement-configuration, in which the probe can be fed to the profiling device until the probe is in contact with the first profiling plate.

An explanation of the probe and its function is located further above in the text. The probe can have, for example, a square or cube-shaped measuring head. The latter itself can be detected particularly simply in its geometry and can also be measured simply in imaging methods.

In particular, the device comprises a grinding slide for feeding the grinding spindle. In this case, it can also comprise a shift slide, which is arranged on the grinding slide and is movably mounted along the Y-grinding-spindle-axis. In this variant, the probe is preferably arranged on the shift slide, for example next to the grinding spindle. In particular, the probe can be designed to be foldable in front of the grinding spindle, for example, about a vertical or a horizontal axis, in particular parallel to the grinding spindle rotation axis. For this purpose, the probe can comprise a pivot arm.

Preferably, the device comprises a control unit, which is designed to cause the device to carry out a method according to the invention. The control unit can be a PC or a PLC, on the memory unit of which commands which carry out the method are stored and can be called up. The control unit can be arranged, in particular, on the device itself and can be operable, for example, by means of a touchscreen. However, it can also be connected merely to the remainder of the device by a data transmission connection. In this variant, the device comprises, in particular, a command unit, which is suitable for receiving the commands of the control unit and converting them into actual actions.

Further advantageous embodiments and combinations of features of the invention result from the following detailed description and the totality of the patent claims.

### BRIEF DESCRIPTION OF THE DRAWINGS

The drawings used to explain the exemplary embodiment show:

FIG. 1A-C an embodiment of a generating grinding machine according to the invention;

FIG. 2 a flow diagram of an embodiment of a method according to the invention;

FIG. 3A-C a further embodiment of a generating grinding machine according to the invention;

FIG. 4 a flow diagram of a further embodiment of a method according to the invention;

FIG. 5A, B a further embodiment of a generating grinding machine according to the invention;

FIG. 6 a profiling device as a stack arrangement;

FIG. 7 a further profiling device as a revolver arrangement; and

FIG. 8 a further profiling device as a round table arrangement.

In principle, the same parts are provided with the same reference numerals in the figures.

### DETAILED DESCRIPTION

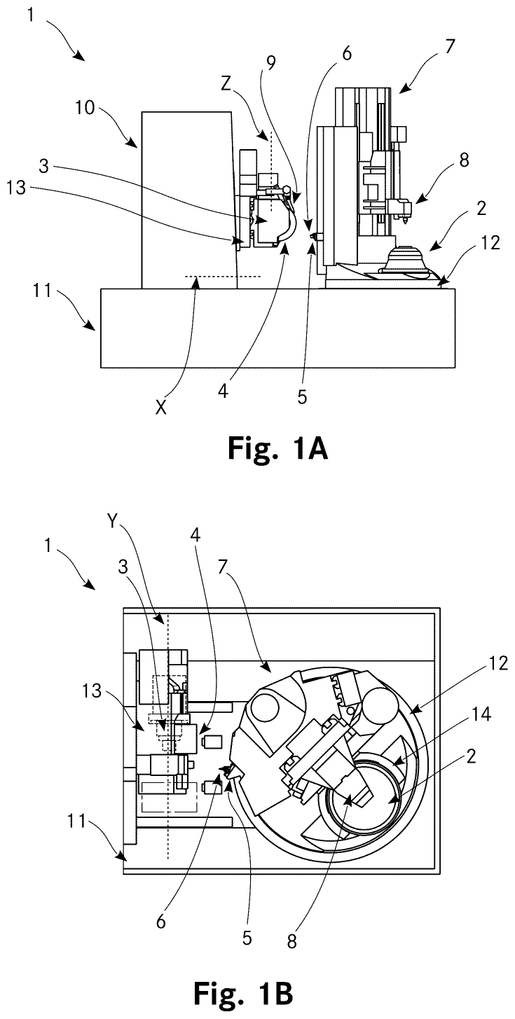

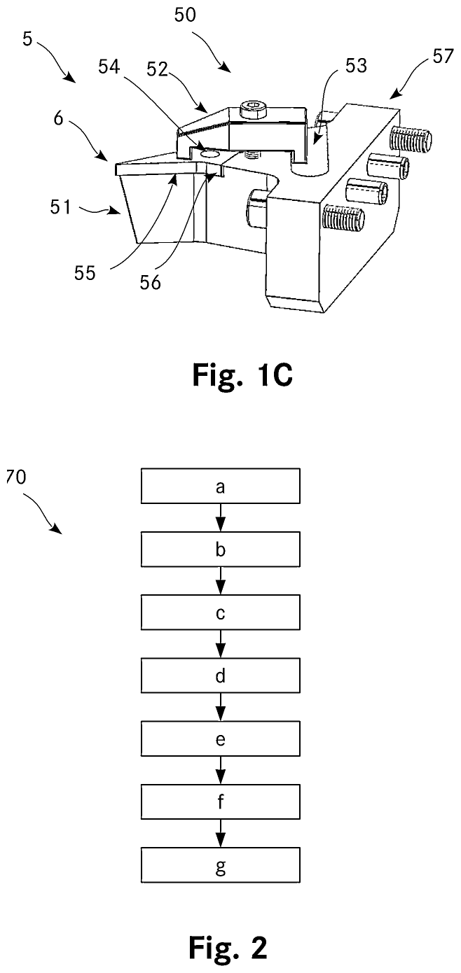

FIGS. 1A and 1B show a first inventive generating grinding machine 1. In this case, FIG. 1A shows the generating grinding machine 1 as a side view and FIG. 1B shows a part of the generating grinding machine 1 in a horizontal section. The generating grinding machine 1 comprises a machine bed 11, on the upper side of which a schematically illustrated grinding slide 10 and a carrier tower 7 oriented vertically (vertically in the image plane of FIG. 1A and orthogonally to the image plane of FIG. 1B) are arranged next to one another. The grinding slide 10 movably mounted with respect to the machine bed 11 comprises a shift slide 13 pointing towards the carrier tower 7, with a grinding spindle 3 for rotating a grinding worm 4 about a rotation axis running substantially horizontally (orthogonally to the image plane of FIG. 1A and vertically in the image plane of FIG. 1B). In the illustrated position of the shift slide 13, the grinding spindle 3 is located approximately at one third of the maximum height of the carrier tower 7. The grinding slide 10 is feedable to the carrier tower 7 along a horizontal axis X. In addition, the shift slide 13 is movable relative to the grinding slide 10 in a vertical axis Z parallel to a rotation axis of a workpiece spindle 2 and along an axis Y (see FIG. 1B) parallel to a rotation axis of the grinding spindle 3. In addition, the rotation axis of the grinding spindle 3 is tiltable by the shift slide 13 by an angle of approximately 40° in both directions with respect to the horizontal plane (as a result of which the axis Y is also tilted). A cooling-oil-nozzle 9, which can supply a region of action around the grinding worm 4 with cooling oil, is likewise arranged on the shift slide 13 and above the grinding spindle 3.

In this case, the carrier tower 7 and a workpiece spindle 2 located next to the carrier tower for rotating a workpiece (not shown) located thereon about a vertically lying rotation axis are arranged on a base 12 rotatably mounted relative to the machine bed 11. In this case, the base 12 is rotatably mounted about a base rotation axis running vertically and centrally through the base 12. Rotations of the base 12 can thus align the workpiece spindle 2 with respect to the grinding slide 10. Arranged on the carrier tower, in addition, a vertically movable tailstock 8 with a tailstock base, which can clamp a workpiece located on the workpiece spindle 2 coming from above, is located above the workpiece spindle 2.

In addition, the generating grinding machine 1 has a gripper 14 which is arranged on the carrier tower 7 and which is capable of gripping and transporting workpieces. The gripper 14 is located on a pivot arm, with which it can be pivoted out about a vertical pivot axis running laterally on the carrier tower 7. When the gripper 14 grips a workpiece and pivots in, the workpiece is positioned such that its workpiece axis coincides with the rotation axis of the workpiece spindle 2. By moving the tailstock 8, it can then be fixed on the workpiece spindle 2. Subsequently, the gripper 14 can be opened and moved away from the workpiece.

In a workpiece-machining-configuration, the base 2 is rotated in such a way that the workpiece spindle 2 points towards the grinding spindle 3 and thus towards the grinding worm 4 (not shown). The shift slide 13 is moved along the axis Z to a height at which the grinding worm 4 has substantially the same height as a workpiece on the grinding spindle 2. Thus, the grinding spindle 2 can be fed to the workpiece spindle by the grinding slide 10 along the axis X until the grinding worm 4 and a workpiece located on the workpiece spindle 2 are operatively connected.

Furthermore, a profiling device 5 which comprises a profiling plate 6 is arranged on the carrier tower 7, on a side of the carrier tower 7 facing away from the workpiece spindle, and thus with respect to the base rotation axis in an angular region which lies outside the angular region of the workpiece spindle 2. Further details of the profiling device 5 are explained further below with reference to FIG. 1C. In this case, the profiling device 5 is fixed on the carrier tower 7 at a vertical height, which lies approximately centrally between the tailstock 8 and the workpiece spindle 2, and outside the base rotation axis. The profiling plate 6 can be pivoted into a grinding-tool-machining-position by a rotation of the base 12. The generating grinding machine 1 can be brought into a profiling configuration by an additional corresponding positioning of the grinding spindle 4, in which the rotation axis of the grinding spindle 4 is located approximately at the height of the profiling plate 6. In the profiling configuration, the grinding spindle 3 can be fed to the profiling device 5 along the axis X until the grinding worm 4 is operatively connected to the profiling plate 6. Thus, the grinding worm 4 can be pre-profiled or completely profiled by the profiling plate 6.

FIG. 1C shows the profiling device 5 together with the profiling plate 6 as an isometric top view. The profiling plate 6 consists of a polycrystalline diamond. At its distal end, it tapers to a point, wherein it has an inner profiling-plate-tip-angle of 15°. The profiling-plate-tip-angle could also have a deviating value, for example an angle between 10° and 30°. The outer profile of its main surfaces consists of two parts: a longer distal part is triangular or arrow-shaped (with the abovementioned profiling-plate-tip-angle) and a shorter proximal part is rectangular, wherein its longest edge represents the proximal end of the profiling plate 6. Here, the outer edges of the proximal part run at an angle to the axis of symmetry of the triangle, with an angle of approximately 40°. In a proximal region, the profiling plate 6 is perforated in a circular manner.

The profiling plate 6 is located within a profiling plate holder 50. The profiling plate holder 50 here consists substantially of two parts, a clamping foot 51 and a clamping element 52. The clamping foot 51 serves as a support and support for the profiling plate 6, while the clamping element 52 presses the profiling plate 6 onto the clamping foot 51 and fixes it in this way. The clamping foot 51 comprises a horizontal receiving surface 55 for receiving the profiling plate 6, wherein the shape of the horizontal receiving surface 55 resembles the shape of the profiling plate 6. A distal region of the receiving surface, which is in contact with the distal part of the profiling plate 6, also tapers to a point in an arrow-shape. In this case, however, the distal tip of the profiling plate 6 lies outside the distal tip of the receiving surface 55. In a distal region, the profiling plate 6 thus projects beyond the clamping foot 51 on all sides, as a result of which, during a profiling operation, the grinding worm 4 comes into operative connection only with the profiling plate 6 and not directly with the clamping foot 51. In the proximal region, the outer edges of the receiving surface 55 and the outer edges of the profiling plate 6 terminate flush with one another. Overall, the receiving surface 55 thus has a surface dimension, which makes up approximately 90% of the surface dimension of the main surface of the profiling plate 6, which is in contact with the receiving surface 55.

A cylindrical fixing pin 54, which passes through the penetration of the profiling plate 6 and terminates flush with the profiling plate 6 on the surface thereof, is also located on the receiving surface 55. The profiling plate 6 is fixed in its position and secured against displacements by the fixing pin 54. Located proximally adjacent to the receiving surface 55 on the clamping foot 51 is a vertical stabilizing surface 56, the rectangular shape of which corresponds to the proximal side surface of the profiling plate 6, wherein the stabilizing surface 56 is also in contact with the profiling plate 6. In particular, rotations of the profiling plate 6 are prevented by the stabilizing surface 56.

The clamping foot 55 is formed in a wedge-like manner below the receiving surface 55. In this case, the distal wedge edge runs to a vertical straight line with an inner angle of approximately 20°, so that the clamping foot retracts below the receiving surface. Thus, with sufficient support of the profiling plate 6, it is ensured that no contact of the clamping foot with the grinding worm 4 occurs. The thickness of the clamping foot 51 below the receiving surface, that is to say the vertical extent between the receiving surface 55 and the underside, corresponds approximately to the maximum horizontal length of the receiving surface. The clamping foot has, outside the receiving surface 55, substantially a thickness, which corresponds to the thickness below the receiving surface 55 with the additional height of the stabilizing surface 56. Behind the stabilizing surface 56, the upper side of the clamping foot thus remains substantially flush with the upper side of the profiling plate 6.

At its end pointing away from the profiling plate 6, the clamping foot 51 has a connecting region 57 which has the shape of a T-piece in the horizontal plane, wherein the receiving region of the profiling plate 6 runs centrally away from the connecting region 57. On both sides of the connecting region 57 there are fastening bolts with external threads which are introduced into horizontal through-holes. With the fastening bolts, the clamping foot 51 is screwed firmly to the carrier tower 7 such that the profiling plate 6 lies horizontally and projects from the carrier tower 7. Additional stabilizing pins which engage in a recess on the carrier tower 7 are located on the clamping foot 51 between the fastening bolts.

The clamping element 52 is fastened to the upper side of the clamping foot 51, behind the receiving surface 55 and the stabilizing surface 56, via a fastening bolt, which engages with its external thread in a bore with internal thread. The clamping element 52 which is C-shaped overall in the vertical plane in this case has a front part which faces the profiling plate 6 and tapers from the fastening bolt in the direction of the profiling plate and ends with a press-on-region which points downwards towards the profiling plate 6. The press-on-region is that part of the clamping element 52, which contacts the upper side of the profiling plate 6 and clamps the profiling plate 6 coming from above onto the receiving surface 55. The rear part of the clamping element 52 facing away from the profiling plate 6 has a stabilizing region which also points downwards and which engages in a recess 53 on the upper side of the clamping foot 51. The clamping element 52 is secured against rotations about the fastening bolt by the interaction of the stabilizing region and the clamping foot 51. The profiling plate 6 is sufficiently strongly supported with the profiling plate holder 50 in order not to be displaced or to break during a profiling operation. At the same time, the profiling plate 6 can be easily replaced by simple loosening of the clamping element 52.

FIG. 2 shows a flow diagram of a method 70 according to the invention. In a first step a, the generating grinding machine 1 from FIGS. 1A-1C is provided with the workpiece spindle 2, the grinding spindle 3, which is feedable along the axis X, for rotating a grinding tool (e.g. the grinding worm 4), and the profiling device 5 with the profiling plate 6. In the following step b, a grinding worm blank (e.g. grinding worm 4, still without grinding profile) is provided on the grinding spindle 3 and mounted on the grinding spindle 3.

In a step c, the profiling is then precalculated by a control unit: all inputs which are necessary for the pre-profiling, such as movement profiles of the grinding slide 10 and of the shift slide 13 and the rotation speed of the grinding spindle 3, which are necessary for the complete pre-profiling, are predetermined. For this purpose, there is in turn the need to know precisely the geometry of the profiling plate 6. A digital twin of the profiling plate 6 is called up, which digital twin represents the state of wear of the profiling plate 6 by simulations of all profiling operations which have taken place with the profiling plate 6. The profiling is precalculated by means of the information from this digital twin. The recalculation can also already take place before the grinding worm blank is mounted.

The generating grinding machine 1 is then brought into the profiling configuration in a step d: for this purpose, the base 12 is rotated in such a way that the profiling device 5 with the profiling plate 6 assumes the position which is closest to the grinding spindle 3, and a radial connecting line from the center of the carrier tower 7 via the profiling plate 6 is orthogonal to the rotation axis of the grinding spindle 3 and therefore to the axis Y (see FIG. 1B). This is the grinding-tool-machining-position of the profiling plate 6. In addition, the shift slide 13 is moved along the axis Z in such a way that the rotation axis of the grinding spindle 3 is located at the same height (along the axis Z) as the profiling plate 6. The shift slide 13 is furthermore moved along the axis Y in such a way that a first outer region of the planned profile lies opposite the profiling plate.

In the following step e, the grinding spindle 3 is fed via the axis X to the profiling device 5 until the grinding worm blank and the profiling plate 6 are operatively connected.

In step f, the grinding worm blank is then preprofiled: The grinding spindle 3 rotates the grinding worm blank clockwise from the perspective of FIG. 1A, with the result that that side of the grinding worm blank which in each case faces the profiling plate 6 moves downwards from above. At the same time, the shift slide 13 moves along the axis Y, at a speed precalculated in step c, from the first outer region of the planned profile the length of the planned profile on the grinding worm to a second outer region. As a result, a grinding worm profile is introduced into the grinding worm blank by the profiling plate 6.

After the profiling plate has passed through the planned grinding worm profile completely once as a result of the movement along the axis Y, a return of the grinding slide 10 along the axis X follows, with the result that the profiling plate 6 and the grinding worm blank no longer contact each other. The shift slide 13 is then brought again into the starting position of the profiling configuration, that is to say repositioned correspondingly along the axis Y.

In a further pass, the grinding spindle 3 is fed again to the profiling plate 6 by the grinding slide 10, and a rotation of the grinding spindle 3 and a movement of the shift slide 13 along the axis Y take place again.

This process can be repeated even further times according to the precalculation in step c. After the preprofiling has been concluded, the grinding slide 10 is returned for the last time.

In step g, the digital twin is now updated by a simulation of the grinding operation, which has taken place, taking account of the collected movement data of step f (the pre-profiling). The digital twin thus represents the new state of wear of the profiling plate 6 and can serve for the precalculation of further pre-profilings.

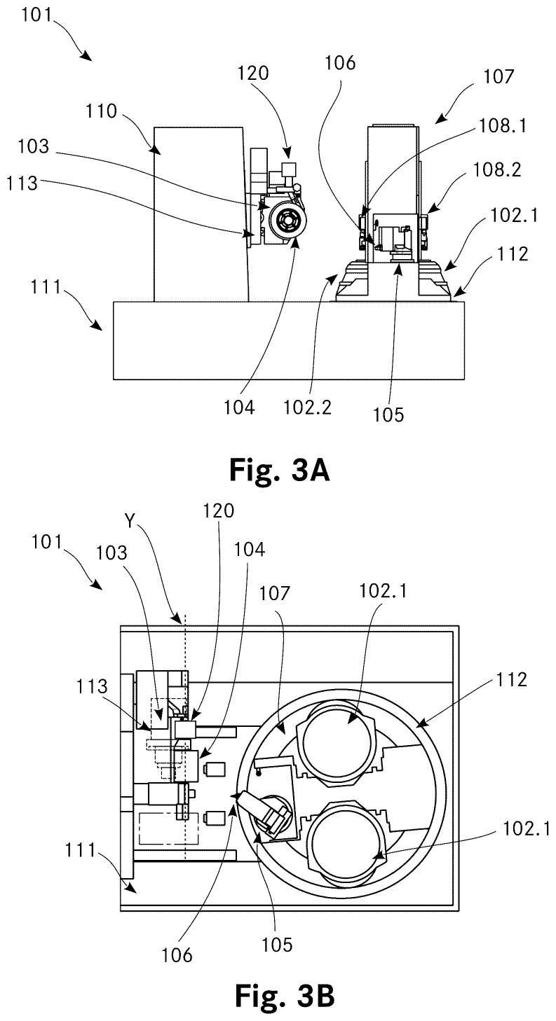

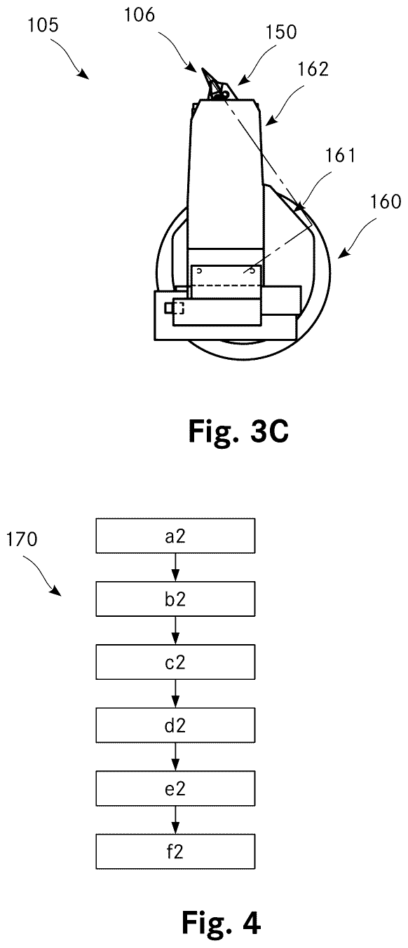

FIG. 3A to 3C show a further generating grinding machine 101 according to the invention or parts thereof. In this case, FIG. 3A shows the generating grinding machine 101 as a direct side view, while FIG. 3B shows the generating grinding machine 101 in a horizontal section at the height of the profiling plate 106. The machine bed 111, the grinding slide 110 and the shift slide 113, the grinding spindle 103, and the rotatable base 112 of the generating grinding machine 101 substantially correspond to those of the generating grinding machine 1 from FIG. 1A and FIG. 1B.

A carrier tower 107 is arranged on the base 112. The generating grinding machine 101 is designed as a multi-spindle module with a first workpiece spindle 102.1 and a second workpiece spindle 102.2 which are arranged on two opposite sides of the carrier tower 107. A first tailstock 108.1 or a second tailstock 108.2 is located on the carrier tower 107, in each case above the workpiece spindles 102.1, 102.2.

The generating grinding machine 101 thus has two workpiece-machining-configurations in which the base 112 is in each case rotated in such a way that one of the two workpiece spindles 102.1, 102.2 faces the grinding spindle 103.

Furthermore, a profiling device 105 with a profiling plate 106 is arranged on one side of the carrier tower 107, which in each case points radially away from the two workpiece spindles 102.1, 102.2 at a 90° angle. This is described in detail further below with reference to FIG. 3C.

The generating grinding machine 101 furthermore comprises a cube-shaped probe 120, which is arranged on the shift slide 113 via a pivot arm. In a profiling-plate-measurement-configuration of the generating grinding machine 101, the otherwise vertically upwardly directed pivot arm of the probe 120 is in a horizontal alignment. The probe 120 is thus located in front of the grinding spindle 103 and the grinding worm 104. The shift slide 113 is furthermore movable along the axis Y in such a way that the probe 120 is located centrally in front of the carrier tower 107. The probe 120 comprises a contact sensor.

Furthermore, the generating grinding machine 101 comprises a control unit, which is designed to correlate movements of the grinding slide 110, of the shift slide 113 and signals of the contact sensor of the probe 120. The wear of the profiling plate 106 can thus be measured by means of the probe 120 (details of the method are explained further below with reference to FIG. 4).

FIG. 3C shows the profiling device 105 of the generating grinding machine 101 (FIG. 3A, 3B) as a direct top view. The profiling plate 106 and the profiling plate holder 150 correspond to the profiling plate 6 and the profiling plate holder 50 of the first embodiment (FIG. 2C). In addition, the profiling device 105 comprises a round pivot base 160, on which a pivot arm 162 is arranged via a holder 161. In this case, the pivot arm 162 has substantially the shape of a cuboid, the horizontal width of which makes up approximately 40% of its horizontal length. The vertical thickness of the pivot arm 162 (see FIG. 2A) corresponds approximately to its horizontal length. In this case, the profiling plate holder 150 is attached to the distal end of the pivot arm 162 such that the underside of the profiling plate holder 150 and the underside of the pivot arm 162 lie approximately at the same height (see FIG. 3A). The arrow-like tip of the profiling plate 106 has an inner angle of approximately 40° to the longitudinal edges of the pivot arm 162.

In the profiling configuration of the generating grinding machine 101, the pivot arm 162 of the profiling device 105 is pivoted away from the carrier tower 107 such that the profiling plate 106 points radially away from the carrier tower (see FIG. 3B).

FIG. 4 schematically shows a further method 170 according to the invention. In step a2, the generating grinding machine 101 is provided. In step b2, a grinding worm blank of the size of the grinding worm 104 is then provided.

In contrast to the method 70 in FIG. 2, in the method 170 from FIG. 4, the profiling plate is first measured in step c2. For this purpose, the generating grinding machine 101 is brought into a profiling-plate-measurement-configuration. This includes a rotation of the base of the carrier tower 107, so that the side of the carrier tower 107 on which the profiling device 105 is located points directly towards the grinding spindle 103. In addition, the pivot arm 162 of the profiling device is pivoted such that the profiling plate 106 points directly towards the grinding spindle 103. In addition, the pivot arm of the probe 120 is pivoted into a horizontal alignment and the shift slide 113 is moved along the axis Y in such a way that the probe 120 is located centrally in front of the carrier tower 107.

Then, by means of the grinding slide 110, the probe 120 is fed to the profiling plate 106 along the axis X until the probe 120 registers a contact. Subsequently, the probe 120 is returned and moved by means of the shift slide 113 along the axis Y by a value which corresponds approximately to half the maximum width of the profiling plate 106. Subsequently, the probe 120 is fed again to the profiling plate 106 until the probe 120 registers a further contact. This procedure is also repeated for the other direction along the axis Y. The geometry of the profiling plate 106, in particular its wear as a result of previous profiling operations, is then determined with reference to the registered contacts and the positions corresponding to a contact along the axes X and Y (and the known geometry of the probe 120). Furthermore, a precalculation of the pre-profiling on the basis of the geometry of the profiling plate 106 determined by the measurement by the control unit of the generating grinding machine 101 follows.

In the next step d2, the generating grinding machine 101 is brought into the profiling configuration. The carrier tower 107 and the profiling device 105 retain the same positions as in the profiling-plate-measurement-configuration, but the probe 120 is pivoted into a vertical alignment. As a result, the grinding worm blank can be fed to the profiling device 105 in step e2 until the grinding worm blank and the profiling plate 106 are operatively connected.

The pre-profiling in step f2 substantially corresponds to step f from the method 70 in FIG. 2, wherein, however, the measured values from step c2 serve as a basis for the movements of the grinding slide 110 and of the shift slide 113.

In contrast to the method 70 from FIG. 2, the method 170 does not require any simulation of the profiling operation in a further step.

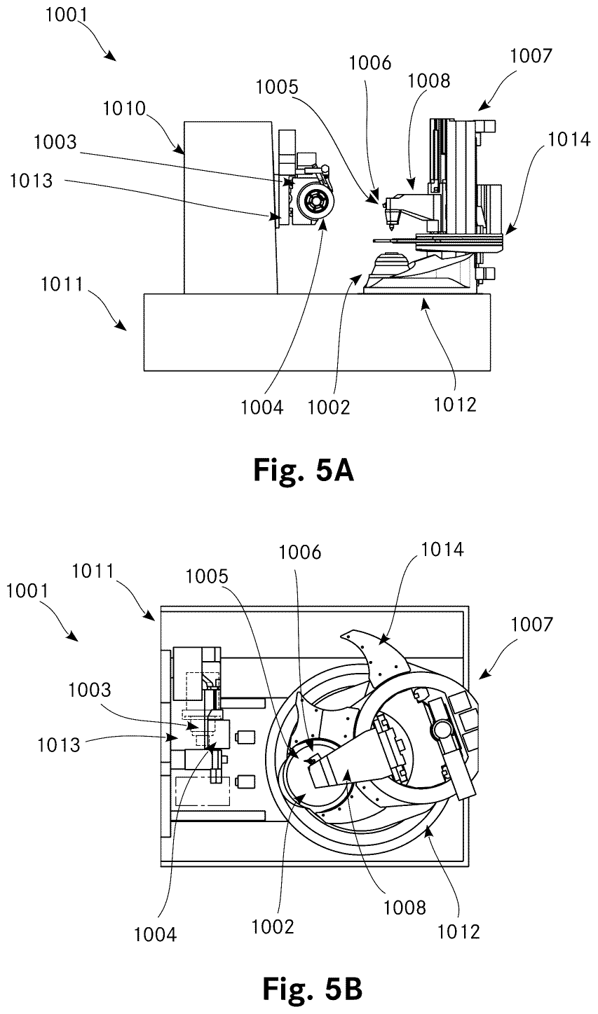

FIGS. 5A and 5B show a further generating grinding machine 1001 according to the invention, wherein FIG. 5A shows the generating grinding machine 1001 as a direct side view and FIG. 5B shows the generating grinding machine 1001 in a horizontal cross section at the height of the profiling plate 1006.

The machine bed 1011, the grinding slide 1010, the shift slide 1013, the grinding spindle 1003 and the grinding worm 1004 are of the same type as in the generating grinding machine 1 and the generating grinding machine 101. The rotatable base 1012 also substantially corresponds to the base 112 from FIG. 3A. A workpiece spindle 1002 is arranged next to the carrier tower 1007. A tailstock 1008, which lies above the workpiece spindle 1002 is located on the carrier tower 1007. At a vertical height between workpiece spindle 1002 and tailstock 1008, the carrier tower 1007 comprises a triple gripper 1014. The triple gripper 1014 comprises individually independently movable gripper elements, which are rotatably mounted about a gripper rotation axis, wherein the gripper rotation axis runs parallel to the base rotation axis, but does not coincide therewith. The triple gripper 1014 serves to transport workpieces flexibly to the workpiece spindle 1002 or away from the workpiece spindle 1002. In addition, workpieces can thus still be held at secondary machining positions outside the generating grinding machine 1001.

The profiling device 1005 with the profiling plate 1006 substantially corresponds to the profiling device 5 with the profiling plate 6 from FIG. 1C, but with a modified proximal fastening part. It is arranged laterally on the tailstock base of the tailstock 1008.

In a profiling configuration of the generating grinding machine 1001, the base 1012 is rotated such that the profiling plate 1006 points directly towards the grinding spindle 1003 (see FIG. 5B). The generating grinding machine 1001 can be used, for example, in a method, which substantially corresponds to the method 70 from FIG. 2.

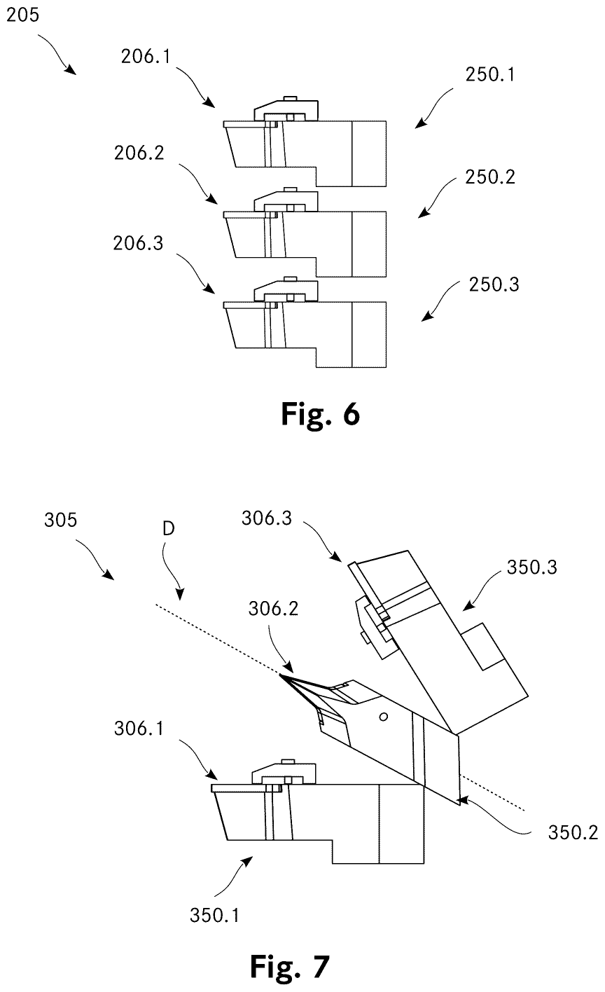

FIG. 6 shows a further profiling device 205 as a lateral top view. The profiling device 205 comprises three profiling plates 206.1, 206.2, 206.3, which are each held in a profiling plate holder 250.1, 250.2, 250.3. The profiling plate holders 250.1, 250.2, 250.3 here substantially correspond to the profiling plate holder 50 from FIG. 1C.

The profiling plate 206.1 has substantially the same shape as the profiling plate 6 from FIG. 1C. The profiling plate 206.2 has a profiling-plate-tip-angle, which is greater than the profiling-plate-tip-angle of profiling plate 206.1 by an amount of 2°. The same applies to profiling plate 206.3, in relation to profiling plate 206.2. The proximal region of all profiling plates 206.1, 206.2, 206.3 in turn corresponds to the profiling plate 6 from FIG. 1C.

The profiling plates 206.1, 206.2, 206.3 and the profiling plate holders 250.1, 250.2, 250.3 are arranged spaced apart from one another along a vertical axis, while their horizontal alignment and position are identical. The vertical spacing, for example between the profiling plates 206.1 and 206.2, corresponds in this case approximately to twice the vertical thickness of the clamping foot of the profiling plate holder 250.1.

The profiling device 205 can be, for example, part of a generating grinding machine, which substantially corresponds to the generating grinding machine 1. For the respective profiling configuration, the grinding spindle then assumes different heights along the axis Z (FIG. 1A) and can thus be fed selectively to one of the profiling plates 206.1, 206.2, 206.3.

The profiling-plate-tip-angles, which deviate from one another in this case, permit a profiling of grinding worms of different size or of grinding profiles of different size and shape.

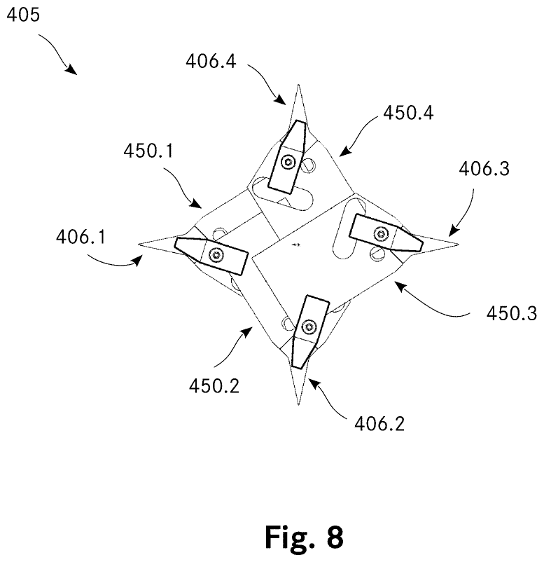

FIG. 7 shows a profiling device 305 designed as a turret profiling device. It comprises three profiling plates 306.1, 306.2, 306.3. In their distal tip, these substantially correspond to the profiling plates 206.1, 206.2, 206.3 from FIG. 6. Unlike the profiling plate 6 from FIG. 1C, the profiling plates 306.1, 306.2, 306.3 are arranged symmetrically about an axis of symmetry running through the respective tip. The proximal region of the profiling plates 306.1, 306.2, 306.3 has the shape of a square, one edge of which lies on the axis of symmetry (see FIG. 8 with the profiling plates 406.1, 406.2, 406.3, 406.4, which have the same shape). On the side lying opposite this edge, the arrow-shaped distal region rises with a profiling-plate tip. The proximal end of the profiling plates 306.1, 306.2, 306.3, 306.4 is thus composed of two side surfaces, which are at a 90° angle to one another.

The profiling plates 306.1, 306.2, 306.3, 306.4 are held by profiling plate holders 350.1, 350.2, 350.3. The profiling plate holders 350.1, 350.2, 350.3 in their distal regions correspond in principle to the profiling plate holder 50 from FIG. 1C and also each consist of a clamping foot and a clamping element. Unlike the profiling plate holder 50 from FIG. 1C, however, they have on the clamping foot two stabilizing surfaces which match the shape of the profiling plates 306.1, 306.2, 306.3.

A respective fastening region of the profiling plate holders 350.1, 350.2, 350.3 has substantially a cuboid shape, wherein the region with the respective profiling plate 306.1, 306.2, 306.3 is formed centrally on a distal edge of this cuboid shape. In their thickness, the profiling plate holders 350.1, 350.2, 350.3 correspond to the vertical thickness of the profiling plate holder 50 from FIG. 1C.

The profiling plate holders 350.1, 350.2, 350.3 are arranged such that the tips of the profiling plates 306.1, 306.2, 306.3 lie on a circular circumference. This circular circumference is located here on an arrangement plane, which is at an angle to an upper main surface of the profiling plate 306.1 at an inner angle of approximately 70°, wherein the arrangement plane lies orthogonally to the tip direction of the tip of the profiling plate 306.1. The profiling plate holders 350.1, 350.2, 350.3 are furthermore arranged such that the respective main side of the profiling plates 306.1, 306.2, 306.3 pointing away from the clamping foot points to a rotation axis D, which rotation axis D runs centrally through the circular circumference and orthogonally to the arrangement plane.

The profiling device 305 is rotatably mounted about the rotation axis D such that each profiling plate 306.1, 306.2, 306.3 can be brought into a horizontal position. The profiling device 305 can be attached, for example, to a generating grinding machine, which corresponds to the generating grinding machine 1 from FIG. 1A and FIG. 1B. It thus offers three different profiling configurations, in which in each case the desired profiling plate 306.1, 306.2, 306.3 is brought into a horizontal position by a rotation of the profiling device 305 about the rotation axis D.

FIG. 8 shows a profiling device 405 designed as a rotary table profiling device as a direct top view. It comprises four profiling plates 406.1, 406.2, 406.3, 406.4, which correspond to the profiling plates 306.1, 306.2, 306.3, 306.4 from FIG. 7. The profiling plate holders 450.1, 450.2, 450.3, 450.4 substantially correspond to the profiling plate holders 350.1, 350.2, 350.3, but in a different arrangement. In addition, the region with the respective profiling plate 406.1, 406.2, 406.3, 406.4 in this embodiment is in each case located laterally on a distal edge of the profiling plate holders 450.1, 450.2, 450.3, 450.4.

In the profiling device 405, the profiling plate holders 450.1, 450.2, 450.3, 450.4 are arranged such that the tips of the profiling plates 406.1, 406.2, 406.3, 406.4 lie on a circular circumference with respect to a horizontal plane and point radially away from the circular circumference. In this case, however, the profiling plates 406.1, 406.2, 406.3, 406.4 are spaced apart from one another vertically, since the profiling plate holders 450.1, 450.2, 450.3, 450.4 are fastened to one another: At the bottom, there is profiling plate holder 450.1, on the upper side of which there is arranged the profiling plate holder 450.2, which is rotated horizontally counterclockwise through 90°. On the upper side of profiling plate holder 450.2, again rotated clockwise through 90°, there is located the profiling plate holder 450.3, and again thereabove, and again rotated through 90°, there is located the profiling plate holder 450.4. In this case, the profiling device 405 is rotatably mounted about an axis which passes centrally through the described circle and orthogonally out of the image plane.

The profiling device 405 can be used on a generating grinding machine such as, for example, generating grinding machine 1 from FIGS. 1A and 1B. In order to adopt the various profiling configurations, the rotary-table profiling device 405 is rotated about its rotation axis such that the desired profiling device points towards the grinding spindle of the generating grinding machine.

The invention is not restricted to the exemplary embodiments illustrated. The generating grinding machines illustrated can be formed differently. They can comprise, for example, a plurality of carrier towers or even none at all. The carrier towers can also be arranged fixedly, that is to say non-rotatably, on the machine bed. The grinding tools can also have larger or smaller diameters. The number of workpiece spindles can vary; thus, for example, three workpiece spindles can also be present on the generating grinding machine. The movement, in particular the closing and resetting of the grinding spindle, can be realized differently, for example with a likewise feedable shift slide. The profiling plates can have a shape other than that illustrated, in particular, for example, a simple triangular shape, a star shape, or a shape with a rounded tip. The profiling-plate holders shown can have other shapes. For example, a profiling-plate holder can hold a plurality of profiling plates. The profiling plates can also be clamped, for example, by two clamping feet in a sandwich arrangement. The rotary table profiling device can also be realized such that all profiling plates lie in a common plane. A turret profiling device could also be realized such that the rotation axis runs parallel to the main surfaces of the profiling plates and all profiling plates point in the same direction.

The methods can deviate from the examples shown. Thus, the measurement of the profiling plate can take place before the grinding tool blank is provided. In each case, only one measurement could also be carried out after each pre-profiling operation or after a certain number of pre-profiling operations. Likewise, the digital twin can be initiated at a different point in time, also, for example, only after the profiling configuration has been assumed. The simulation of the profiling operation could also already take place before the pre-profiling, for example, on the basis of the input values calculated beforehand and not on the basis of movement data actually recorded. A grinding tool can move past the profiling plate more often or less often along the axis Y. It is also possible that, after passing through, the grinding device is rotated about a horizontal axis which is orthogonal to the grinding spindle rotation axis, and subsequently moves past the profiling plate in the opposite direction along the axis Y.

In summary, it should be noted that a method and a device are provided which permit both the hard fine machining of workpieces and a pre-profiling of grinding tools.

What is claimed is:

1. A method for pre-profiling a grinding tool, the method comprising:
a) providing a device for hard fine machining of workpieces and for pre-profiling grinding tools, including:
a. a workpiece spindle for rotating a workpiece;
b. a grinding spindle, which is feedable at least along a X-grinding-spindle-infeed-axis, for rotating a grinding tool; and
c. a profiling device with a fixed first profiling plate,
b) providing a grinding tool blank on the grinding spindle of the device;
c) bringing the device into a profiling configuration;
d) feeding the grinding spindle until the grinding tool blank is operatively connected to the first profiling plate; and
e) pre-profiling the grinding tool blank.

2. The method according to claim 1, wherein the bringing the device into the profiling configuration comprises moving the first profiling plate along a circular path into a grinding tool machining position.

3. The method according to claim 1, wherein the bringing the device into the profiling configuration comprises moving the grinding spindle along a Z-grinding-spindle-axis, which runs parallel to a workpiece rotation axis, into a grinding spindle profiling height.

4. The method according to claim 1, wherein the first profiling plate, after completion of the pre-profiling, is moved into a waiting position, in which the first profiling plate is located outside a feeding region between the grinding spindle and the workpiece spindle.

5. The method according to claim 1, wherein, during the pre-profiling, the grinding spindle, in a Y-operative-connection-movement-region, within which the grinding tool blank located on the grinding spindle remains operatively connected to the first profiling plate, is moved along a Y-grinding-spindle-axis, which Y-grinding-spindle-axis runs parallel to a grinding spindle rotation axis of the grinding spindle.

6. The method according to claim 1, herein, during the pre-profiling, a clamping foot of a profiling plate holder contacts and supports one side of the first profiling plate, which side substantially has a surface normal, which points in the same direction as the rotation direction of the grinding tool blank in a local operative-connection-region of the grinding tool blank and the profiling plate.

7. The method according to claim 1, wherein, before the bringing the device into a profiling configuration, a measurement of the first profiling plate is carried out, wherein, for the measurement, the first profiling plate is brought into contact with a probe.

8. The method according to claim 7, wherein, before the measurement of the first profiling plate, the probe is fed to the profiling device until the probe and the first profiling plate contact each other.

9. A device for hard fine machining of workpieces and for profiling grinding tools, comprising:
a) a workpiece spindle for rotating a workpiece;
b) a grinding spindle, which is feedable at least along an X-grinding-spindle-feed-axis, for rotating a grinding tool,
wherein the device has a workpiece-machining-configuration in which the grinding spindle is configured to be fed to the workpiece spindle along the X-grinding-spindle-feed-axis until a grinding tool located on the grinding spindle is operatively connected to a workpiece located on the workpiece spindle; and
c) a profiling device, including a fixed first profiling plate, wherein
the device has a first profiling configuration in which the grinding spindle is configured to be fed to the profiling device until the grinding tool located on the grinding spindle is operatively connected to the first profiling plate.

10. The device according to claim 9, wherein the first profiling plate is movable into a waiting position, in which the first profiling plate is located outside a feeding region along the X-grinding-spindle-infeed-axis between the grinding spindle and the workpiece spindle.

11. The device according to claim 9, wherein the profiling device comprises a pivotably mounted pivot arm, and wherein the first profiling plate is arranged at a distal end of the pivot arm.

12. The device according to claim 9, wherein the grinding spindle is movable along a Y-grinding-spindle-axis, which Y-grinding-spindle-axis runs parallel to a grinding spindle rotation axis of the grinding spindle, and wherein, in the first profiling configuration, a Y-operative-connection-movement-region exists, within which a grinding tool located on the grinding spindle is operatively connected to the first profiling plate.

13. The device according to claim 9, wherein the grinding spindle is movable along a Z-grinding-spindle-axis, which Z-grinding-spindle-axis runs parallel to a workpiece rotation axis of the workpiece spindle, and wherein the grinding spindle assumes a grinding spindle profiling height along the Z-grinding-spindle-axis in the workpiece-machining-configuration.

14. The device according to claim 9, wherein the device comprises a carrier tower.

15. The device according to claim 14, wherein the profiling device is arranged on the carrier tower.

16. The device according to claim 15, wherein the carrier tower and the workpiece spindle are arranged on a rotatable base, and wherein the profiling device, with respect to a base rotation axis, is arranged in an angular region outside a workpiece-spindle-angular-region on the carrier tower.

17. The device according to claim 14, further comprising a dressing device arranged on the carrier tower, and wherein the profiling device is arranged on the dressing device.

18. The device according to claim 15, further comprising a workpiece tailstock arranged on the carrier tower with a tailstock base, and wherein the profiling device is arranged on the tailstock base.

19. The device according to claim 9, wherein the first profiling plate comprises a cutting element made of polycrystalline diamond.

20. The device according to claim 9, wherein the first profiling plate has a first distal profiling-plate-tip-angle of 1° to 50°.

21. The device according to claim 9, wherein the profiling device has a first profiling plate holder, which holds the first profiling plate, comprising:
a) a first clamping foot, wherein the first clamping foot has a first receiving surface in contact with the first profiling plate, and
b) a first clamping element configured to press the first profiling plate onto the first receiving surface.

22. The device according to claim 21, wherein a first receiving-surface-dimension of the first receiving surface is between 50% and 95% of a first profiling-plate-main-surface-dimension of the first profiling plate.

23. The device according to claim 21, wherein the first clamping foot has a thickness perpendicular to the first receiving surface, which corresponds to at least 70% of a maximum length of the receiving surface.

24. The device according to claim 21, wherein the first clamping foot has, adjacent to the first receiving surface, at least one first stabilizing surface, which supports the first profiling plate against slipping within the first profiling plate holder.

25. The device according to claim 9, wherein the profiling device comprises a second profiling plate.

26. The device according to claim 25, wherein the profiling plates of the profiling device have a first profiling-plate-tip-angle of the first profiling plate and a second profiling-plate-tip-angle of the second profiling plate, and wherein the profiling-plate-tip-angles in each case have a difference from one another of at least 2°.

27. The device according to claim 25, wherein a first distal profiling-plate-tip of the first profiling plate and a second distal profiling-plate-tip of the second profiling plate, are arranged on a circular circumference with respect to an arrangement plane, wherein the profiling device is pivotably or rotatably mounted about a transposition axis running orthogonally to the arrangement plane and centrally through the circular circumference, so that each profiling-plate-tip can be aligned with the grinding spindle, and wherein the arrangement plane runs either parallel, or at an angle to a main surface of the first profiling plate.

28. The device according to claim 25, wherein the profiling device is a stack-profiling-device, wherein a first distal profiling-plate-tip of the first profiling plate and a second distal profiling-plate-tip of the second profiling plate, are spaced apart from one another along a stacking axis, which runs orthogonally to a main surface of the first profiling plate, and are aligned identically with respect to a plane, which runs parallel to the main surface of the first profiling plate.

29. The device according to claim 9, further comprising a probe, wherein the device has a first profiling-plate-measurement-configuration, in which the probe is configured to be fed to the profiling device until the probe is in contact with the first profiling plate.
